(19) United States
(12) Patent Application Publication
(10) Pub. No.: US 2013/0023037 A1
(43) Pub. Date: Jan. 24, 2013

(54) Compost organic-matter accelerated bioremediation

(71) Applicants: Robert T. Kiely, Fredericton (CA); Rodney J. Fry, Fredericton (CA)

(72) Inventors: Robert T. Kiely, Fredericton (CA); Rodney J. Fry, Fredericton (CA)

(21) Appl. No.: 13/507,627

(22) Filed: Jul. 16, 2012

Related U.S. Application Data
(60) Provisional application No. 61/457,959, filed on Jul. 19, 2011.

(51) Int. Cl. B09C 1/10

(52) U.S. Cl. 435/262.5

(57) ABSTRACT

The process for bioremediation of contaminated sludge including the steps of mixing the contaminated sludge with immature compost in the thermophilic phase; nutrients; inoculants; enzymes and microbes. The mixed composition is composted indoors by microbial breakdown, by controlling temperature; moisture; aeration, porosity and pH. The mixed composition is matured by fungal breakdown, by setting the mixed composition outdoors in windrows. The mixed composition is then stabilized by spreading it on a soil surface in a layer of less than one meter thick.

This application claims the benefit of U.S. Provisional Application No. 61/457,959 filed Jul. 19, 2011.

### FIELD OF THE INVENTION

This invention pertains to a process for ex-situ bioremediation of contaminated soil, particularly it pertains to a process for bioremediation of sludges contaminated with petroleum and/or metal-containing pollutants.

### BACKGROUND OF THE INVENTION

Land sites contaminated with petroleum and/or heavy metal contaminants for examples, are unable to be used for residential housing development, fanning or commercial purposes unless the contaminants are removed or reduced to safe levels. Conventional methods of treating such contaminated sites include removing the contaminated soil and transporting the soil to landfill sites, or incinerating the contaminated soil. More recently, methods of treatment of contaminated sites include bioremediation of the soil to remove the pollutants from the soil.

Removal of contaminated soil to landfill is very costly and only shifts the problem to another location and to another generation. Incineration of contaminated soil is very costly and itself represents an environment problem due to smoke, fumes and vapours it generates.

Bioremediation processes use micro-organisms to break down pollutants in contaminated soil. Typically, a bioremediation process involves enhancing the growth of organisms already present in the soil through the addition of fertilizer and oxygen. In most cases, microbes are added to the soil to increase rates of biodegradation. However, this method typically requires extended periods of time, often a number of years for the soil to be decontaminated to an acceptable level. Also, this method is somewhat limited as the microbes and bacteria added must have an affinity with the contaminants present.

The prior art literature describes different processes for bioremediation of contaminated soils but none offers a more general method for accelerating bioremediation processes to reasonable time periods when treating contaminated soils from various sources. A good inventory of the bioremediation processes described in the prior art include:

U.S. Pat. No. 4,415,661 issued to M. J. Thirumalachar et al. on Nov. 15, 1983. This document discloses a process for microbial degradation of petroleum contaminants. The method includes the mixing of a fungus with the petroleum contaminants. A fungus carrier in the form of biomass may also be included.

U.S. Pat. No. 4,494,975 issued to M. F. L. P. DeBoodt et al., on Jan. 22, 1985. This document discloses a composting composition for producing a fertilizer. The process uses petroleum sludge and an organic biomass. The biomass may contain animal manures and residues from the wood industries.

U.S. Pat. No. 5,100,455 issued to J. A. Pinckard on Mar. 31, 1992. This document discloses a process for bioremediation of soils contaminated with petroleum hydrocarbons. The process includes the step of mixing the contaminated soil with special humic microbial substrate with its contained microorganisms to transform the soil into harmless end products. As part of the treatment, the contaminated material is arranged in windrows and mixed on a weekly basis.

U.S. Pat. No. 5,336,290 issued to D. B. Jermstad on Aug. 9, 1994. This document discloses a process for remediation of hydrocarbon-contaminated soil. The process includes the mixing of the contaminated soil with activated sewage sludge to create a useful non-waste product.

U.S. Pat. No. 5,498,337 issued to A. Leon-Betanzoz et al. on Mar. 12, 1996. This document discloses a process for the biodegradation of crude oil wastes. The process includes the steps of forming a sludge with the crude oil wastes; and forming a humus of the sludges through fermentation and putrefaction by enriching the sludge with sawdust, rice husks, sugar cane bagasse and animal excrement.

U.S. Pat. No. 5,888,396 issued to F. A. Perriello on Mar. 30, 1999; and U.S. Pat. No. 6,245,235 issued to F. A. Perriello on Jun. 12, 2001. These documents disclose processes for the bioremediation of hydrocarbon pollutants using a butane-utilizing bacteria.

U.S. Pat. No. 6,413,017 issued to J. B. Scott et al., on Jul. 2, 2002. This document discloses a process for the conversion of hydrocarbon-contaminated soil into fertile soil. One step in the process consists of forming piles and composting the piles under natural atmosphere. The contaminate soil are mixed with biomass that includes animal waste and plant-derived biomass. The piles are left undisturbed for one to several days. The conversion can take up to twelve months.

U.S. Pat. No. 6,652,752 issued to O. P. Ward et al. on Nov. 25, 2003. This document discloses a process for biodegradation of oil sludge. The process includes the steps of forming an aqueous solution containing bacterial culture and nutrients for the bacterial culture. The bacterial culture may be inoculated into an aqueous medium consisting of the nutrients, supplemented with petroleum hydrocarbons and incubated in an aerated reactor or fermenter or other culture vessel.

UK Patent Appl. GB 2,440,331 published by M. Jones et al., on Jan. 30, 2008. This document discloses a process for treating soil contaminated with hydrocarbon. Steps in the process comprises adding microbes; forming windrows and leaving it to ferment for 12 months.

European Patent Application EP 1,352,694 published by M. E. Scevola, on Oct. 15, 2003. This document discloses a composition for the bioremediation of soils contaminated with hydrocarbons. The composition includes a compost containing animal manure and bacteria or mould.

Chinese Patent Application CN 101781131 published by B. Chen et al. on Jul. 21, 2010. This document discloses a method for composting sludge containing heavy metal. Mushroom compost and pig manure are used in the process.

PCT Publication WO 2008/121079 published by G. Poi et al. on Oct. 9, 2008. This document discloses a process for treating sludge containing hydrocarbons. The process includes the step of seeding the sludge with a specific microorganism.

Although several methods for soil bioremediation have been found in the prior art, there remains a need for bioremediation ofpetroleum or metal-contaminated soils from various sources in a more efficient manner.

### SUMMARY OF THE INVENTION

In the present invention, however, there is provided a process which can be applied more generally for ex-situ bioremediation of petroleum and/or metal-impacted sludges from various sources and which can be completed in approximately 24 months.

The process of the present invention includes the steps of:
1) Mixing the contaminated sludge with; immature compost in the thermophilic phase; nutrients; inoculants; enzymes and microbes;
2) Composting the mixed composition by microbial breakdown by controlling temperature; moisture; aeration, porosity and pH, during a period of about 3 months;
3) Maturing the compost by fungal breakdown by setting outdoors in windrows during a period of about 6-9 months;
4) Stabilizing the remediated soil by spreading the composting material on a soil surface in a layer of less than one meter thick for a period of about 6-12 months.

In another aspect of the present invention, a preferred composting composition, or a mixed composition as referred to herein, is made of:
1 part contaminated sludge;
3 parts active compost in the thermophilic phase;
½ part raw poultry manure; and
½ part coarse tree bark for structure and porosity.

This mixed composition is advantageous for accelerating the biologic activity in the contaminated material. This composition is also advantageous for treating contaminated sludges from many different sources.

The resulting end-product of the process according to the present invention is stable and resembles an earthly substance that can be safely re-utilized within a topsoil or as a soil amendment product.

This brief summary has been provided so that the nature of the invention may be understood quickly. A more complete understanding of the invention can be obtained by reference to the following detailed description of the preferred embodiment thereof in connection with the attached drawing.

### BRIEF DESCRIPTION OF THE DRAWING

A preferred embodiment of the present invention is illustrated in the accompanying drawing, in which:

FIG. 1 is a schematic diagram illustrating in a general manner the process according to the preferred embodiment of the present invention.

### DETAILED DESCRIPTION OF THE PREFERRED EMBODIMENT

The process according to the preferred embodiment of the present invention utilizes an ex-situ waste treatment technique which includes the addition of active elements for initiating and accelerating biological decomposition, adsorption/adherence and bioremediation of the chemicals of concern within the sludge materials.

More specifically, the process according to the present invention includes four steps, as follows:

Step 1: Receiving and Mixing (Mixing)

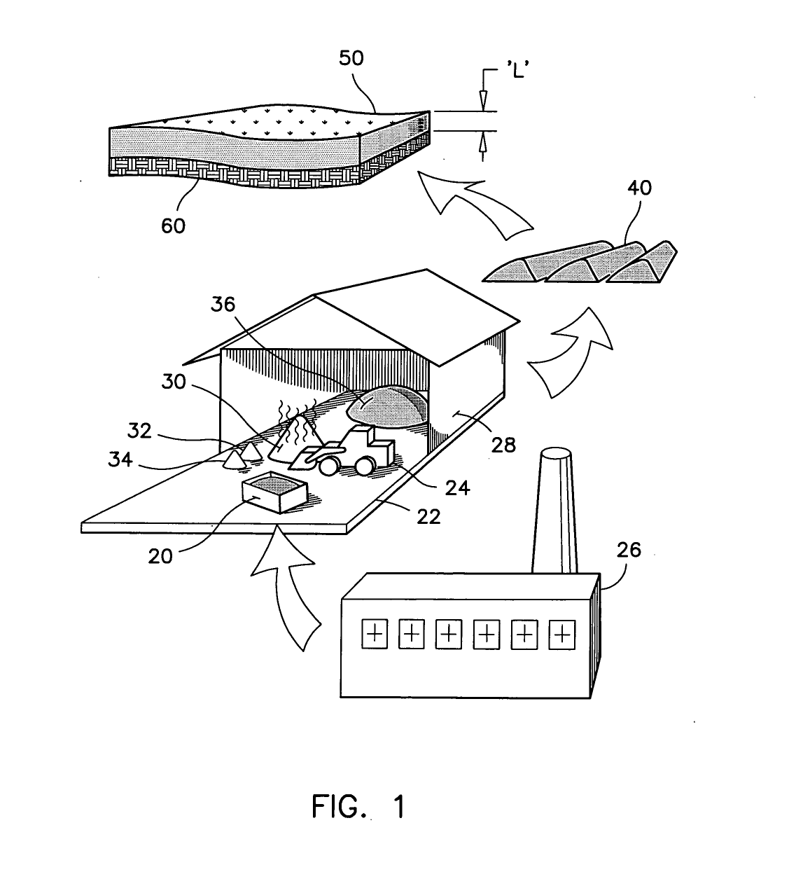

Referring to FIG. 1, petroleum and/or metal impacted sludge waste 20 in bulk or in containers is delivered to a concrete pad 22 where it is mixed/amended using a front end loader 24 for example.

Sludge wastes 20 mentioned above are from sources 26 including the pulp and paper industry; oil refineries; residential wastes; farming and agricultural operations; fish processing plants; mining operations; municipal sewage, and/or agri-food industries.

The concrete pad 22 preferably extends inside a building 28 having appropriate air and leachate control and treatment equipment. These equipment are not illustrated because this is not the focus of the present invention. Similarly, the building 28 is not essential. The mixing of the sludge waste 20 with the active elements mentioned hereinafter can be done outdoors, or inside two or three retaining walls to facilitate the scooping of the material from the pad 22.

The active elements to be mixed with the contaminated soil include immature compost 30 in the thermophilic phase, nutrients, inoculant enzymes and microbes. The expression “thermophilic phase” is used herein in its true meaning. The expression designates a compost that is currently near a peak of its active phase, and wherein the temperature thereof is above a mid-range that is common for the type of compost used.

This recipe of active elements initiates high-rate biological breakdown processes with target initial C:N:P ratio of approximately 120:10:2. For example, a preferred mixed composition recipe is made of: 1 part of contaminated sludge 20; 3 parts of active, or immature, thermophilic phase compost 30 (made from sewage biosolids and carbon amendment); ½ part of raw poultry manure 32; ½ A part of coarse tree bark 34 for structure and porosity.

The sludge container 20 and the piles of active elements 30, 32, and 34 and other details in FIG. 1 are not drawn to scale and may not be representative of a commercial bioremediation facility. The illustration in FIG. 1 is provided only to facilitate the description of the preferred embodiment of the present invention.

Step 2: Primary Remediation (Composting)

The primary phase has been designed to activate thermophilic composting microbes within the mixed composition, to create heat. Heat improves the remediation of contaminants through evaporation, biological degradation, decomposition and adsorption. The mixed composition as prepared during the mixing phase is arranged in one or more piles 36. During this phase, environmental parameters such as temperature, air-flow/oxygen supply, moisture, density/porosity, and pH are maintained at optimum conditions for composting. This phase is preferably carried out inside a building 28 to ensure a better control of moisture within the piles 36 and of leachate and air quality near the bioremediation facility. This step is carried out for a period of about 3 months.

It will be appreciated that a water spray and mechanical mixing of the piles 36 of mixed composition may be effected at time intervals to homogenize the piles and to maintain ideal conditions for biological breakdown of the contaminants in the material.

Step 3: Secondary Composting in Windrows (Maturing)

Following completion of the composting phase, the mixed composition is moved outdoors and piled in windrows 40 for maturation. During this phase, the mixed composition's fertility improves and natural soil organisms are reactivated. A number of tests are collected in the windrows to confirm that contaminant counts are within acceptable levels. This step is carried out for a period of about 6-9 months depending on the weather; the longer period being required when outside temperature is relatively cold.

Again, it will be appreciated that the windrows 40 may be mechanically turned over and mixed to aerate the mixed composition and to promote composting.

Step 4: Stabilizing as End-Use Products (Stabilizing)

The mixed composition 50 is moved from the windrows 40 and it is laid over the soil surface 60 in a layer having a thickness ‘L’ of less than one meter thick. Layers of less than one meter thick provide optimal conditions for further maturing the composting mixture, while supporting seed germination and plant growth. Further end-product mixing, screening, additions of fertilizers, or seeding may be completed to meet the specifications of the end user. This phase is carried out for a period of about 6-12 months.

This stabilizing phase may be carried out in its end-use setting at the client's premises for example. The stabilizing phase can also be carried out at the same location as the maturing phase, by simply spreading the windrows 50 wider and flatter, pending the transportation of the remediated material to a final setting.

Typical markets for the remediated material include commercial-grade compost, manufactured topsoil, erosion control mulches, brown-field remediation, and landfill cap material.

What is claimed is:

1. A process for bioremediation of contaminated sludge, including the steps of;
mixing said contaminated sludge with immature compost in the thermophilic phase thereby forming a mixed composition, and
composting said mixed composition.

2. The process as claimed in claim 1, wherein a ratio of said immature compost to said contaminated sludge is 3:1.

3. The process as claims in claim 1, wherein said step of composting is carried out indoors for a period of three months.

4. The process as claimed in claim 2, wherein said immature compost is made from sewage biosolids and carbon amendment.

5. The process as claimed in claim 2, further including the step of mixing said mixed composition with; nutrients; inoculants; enzymes and microbes.

6. The process as claimed in claim 2, further including the step of mixing said mixed composition with poultry manure and tree bark.

7. The process as claimed in claim 6, wherein a ratio of said poultry manure to said contaminated sludge is ½:1.

8. The process as claimed in claim 7, wherein a ratio of said tree bark to said contaminated sludge is ½:1.

9. The process as claimed in claim 8, wherein said contaminated sludge contains contaminants of petroleum nature, metal nature or both petroleum and metal nature.

10. The process as claimed in claim 3, further including the step of maturing said mixed composition by setting said mixed composition outdoors in windrows.

11. The process as claimed in claim 10, wherein said step of maturing is carried out for a period of 6-9 months.

12. The process as claimed in claim 11, further including the step of stabilizing said mixed composition by setting said mixed composition on a soil surface in a layer of less than one meter thick.

13. The process as claimed in claim 12, wherein said step of stabilizing is carried our for a period of 6-12 months.

14. The process as claimed in claim 13 wherein said step of stabilizing is carried out at a client's premises as an end-use product.

15. A process for bioremediation of contaminated sludge, including the steps of
mixing said contaminated sludge with immature compost in the thermophilic phase; nutrients; inoculants; enzymes and microbes, thereby forming a mixed composition;
composting said mixed composition indoors by microbial breakdown, by controlling temperature; moisture; aeration, porosity and pH;
maturing said mixed composition by fungal breakdown, by setting said mixed composition outdoors in windrows;
stabilizing said mixed composition by spreading said mixed composition on a soil surface in a layer of less than one meter thick.

16. The process as claimed in claim 15, wherein said step of composting is carried out for a period of about 3 months; said step of maturing is carried out for a period of about 6-9 months, and said step of stabilizing is carried out for a period of about 6-12 months.

17. The process as claimed in claim 15, wherein said immature compost is made from sewage biosolids and carbon amendment.

18. The process as claimed in claim 15, wherein said mixed composition includes;
1 part of said contaminated sludge;
3 parts of said immature compost in the thermophilic phase;
½ part of raw poultry manure, and
½ A part of coarse tree bark.

19. The process as claimed in claim 15, wherein said contaminated sludge is obtained from one or more of a plurality of sources comprising pulp and paper industries; oil refineries; residential residues; farming operations; fish processing plants; mining industries; municipal sewage and agricultural food industry, or from a combination of said sources.

20. The process as claimed in claim 19, wherein said contaminated sludge contains contaminants of petroleum nature, metal nature or both petroleum and metal nature.
